(19) United States
(12) Patent Application Publication
(10) Pub. No.: US 2014/0068411 A1
(43) Pub. Date: Mar. 6, 2014

(54) METHODS AND APPARATUS TO MONITOR USAGE OF INTERNET ADVERTISING NETWORKS

(71) Applicants: Scott Ross, Austin, TX (US); Binlay Low, Saratoga, CA (US); Vianney Dervaux, Dublin, CA (US)

(72) Inventors: Scott Ross, Austin, TX (US); Binlay Low, Saratoga, CA (US); Vianney Dervaux, Dublin, CA (US)

(21) Appl. No.: 13/630,818

(22) Filed: Sep. 28, 2012

Related U.S. Application Data
(60) Provisional application No. 61/695,856, filed on Aug. 31, 2012.

(51) Int. Cl. G06F 17/00

(52) U.S. Cl. 715/234

(57) ABSTRACT

Methods and apparatus to monitor usage of Internet advertising networks are disclosed. An example method includes identifying, by inspecting a Page Info interface of a browser with a processor, a first universal resource locator (URL) of a webpage displayed by the browser. A media element displayed on the webpage is identified. A second URL associated with the media element displayed on the webpage is gathered. A log of network communications to identify a request for the second URL is inspected. A referrer URL is identified within a header of the request, the referrer URL being different from the first URL. A record of the referrer URL is stored in association with the first URL.

### RELATED APPLICATION

This patent claims priority to U.S. Provisional Patent Application Ser. No. 61/695,856, which was filed on Aug. 31, 2012 and is hereby incorporated herein by reference in its entirety.

### TECHNICAL FIELD

The present disclosure pertains to Internet usage monitoring and, more specifically to, methods and apparatus to monitor usage of Internet advertising networks.

### BACKGROUND

Companies that advertise products and/or services on the Internet often utilize advertisement networks. An advertisement network is an intermediary between the companies advertising products and the web sites that such advertisements are actually displayed on.

Companies that advertise their products or services on the Internet have an interest in determining how users consume their advertisements. Internet monitoring can be achieved in a number of ways. For example, monitoring can be performed at the client-side to monitor user activities. Alternatively, monitoring can be performed at the server-side to track and/or count served webpages.

### BRIEF DESCRIPTION OF THE DRAWINGS

FIG. 1 illustrates a known transaction log of browsing events.

FIG. 2 is a block diagram of an example system constructed in accordance with the teachings of this disclosure to monitor usage of an Internet advertising network.

FIG. 3 is a block diagram of the example browser monitor of FIG. 2.

FIG. 4 is a communication diagram illustrating example requests and responses made for retrieving elements to be displayed as part of an example webpage.

FIG. 5 is a diagram of example of Page Info data.

FIG. 6 is a diagram of an alternate example of Page Info data.

FIG. 7 illustrates an example hypertext transfer protocol (HTTP) request header.

FIG. 8 illustrates an example enhanced transaction log of browsing events, including associations of the requested Universal Resource Locators (URLs) with parent URLs and referrer URLs.

FIG. 9 is a diagram illustrating how elements identified by Page Info data from multiple browser tabs may be associated with HTTP request headers.

FIG. 10 is a flowchart representative of example machine-readable instructions that may be executed to implement the example browser monitor of FIGS. 2 and 3.

FIG. 11 is a flowchart representative of example machine-readable instructions that may be executed to implement block 1005 of FIG. 10.

FIG. 12 is a flowchart representative of example machine-readable instructions that may be executed to implement block 1010 of FIG. 10.

FIG. 13 is a flowchart representative of example machine-readable instructions that may be executed to implement block 1020 of FIG. 10.

FIG. 14 is a block diagram of an example processor platform that may execute, for example, the machine-readable instructions of FIGS. 10, 11, 12, and/or 13 to implement the example browser monitor of FIGS. 2 and/or 3.

### DETAILED DESCRIPTION

Internet monitoring systems may be implemented in various configurations based on the data that is intended to be collected. For example, a server hosting a server-based Internet monitoring system tracks how users interact with that server. The resulting server-based monitoring data includes detailed information about how users utilize the server, but will not provide data on how the users interact with other servers. Proxy server based Internet monitoring systems track how a group of users interact with a plurality of servers hosting various websites. For example, an Internet service provider that manages a proxy server to serve web pages may utilize the proxy server to monitor what websites users utilizing the proxy visit while using the Internet service. Client-side Internet monitoring systems monitor the Internet activity of a specific user who is operating a browser on a client computer. In such client-side Internet monitoring systems, monitoring data that is collected by the system can be very detailed due to higher levels of available processing power, the ability to monitor system calls and/or applications (e.g., a browser, a word processing program) being run locally on the client computer, the ability to track interactions with input devices (e.g., mouse clicks and/or movements, keystrokes on a keypad, etc.), the ability to detect access to cached content (e.g., a previously loaded webpage accessed from memory rather than from a fresh request to the Internet), and/or the ability to identify the user associated with the client device. Client-side monitoring thereby allows a wide range of web sites to be monitored while adding the ability to associate web usage data with specific users, groups of users, and/or demographics; and allows collecting of more parameters and/or more detailed monitoring data.

A browser is a software tool used to view Internet content on a client computer. To obtain web content, the browser sends an HTTP (Hypertext Transfer Protocol) request for the web content over a network (e.g., the Internet) to a server at an Internet address specified by a Universal Resource Locator (URL). The server sends a response containing the web content and/or links to the web content to the browser. The browser then proceeds to render the content for presentation (e.g., display) to the user. (As used herein, “content” includes any type of material including webpages, news, entertainment, advertisements, information, etc.) The user may then interact with the browser and/or the content being rendered. The browser can be any Internet browsing application. For example, the browser may be implemented by any type of browser such as any version of Microsoft Internet Explorer®, Mozilla Firefox®, Apple Safari®, Google Chrome™, etc. Additionally or alternatively, the user may utilize multiple browsers simultaneously to view multiple web pages. Further, the browser may not be a standard Internet browser as listed above, rather the browser may be integrated into another application on the user's computer. For example, an iPhone app that permits a user to access content at a particular website may act as a browser of limited functionality.

Users typically view content (which may include one or more webpages) in a browser for a given time period. This period is known as a browsing session. Browsing sessions can be any duration. For example, a user may use their browser to check a weather forecast on a first webpage during a browsing session that may only last a few minutes, or even a matter of seconds. If, instead, the user accesses the weather on the first webpage and then reads a long article or series of articles on one or more other webpages, the duration of the browsing session may be many minutes or even over an hour. In examples illustrated herein, a browsing session is defined as the time period that the browser was running irrespective of how many webpages are accessed during the time period. The user may start the browsing session by, for example, starting the browser, and may terminate the browsing session by, for example, exiting or closing the browser.

Client-side monitoring of Hypertext Transfer Protocol (HTTP) traffic generated by a user is performed in order to determine the user's web usage habits. The data collected via such monitoring can be beneficial to media monitoring and advertising companies. The collected HTTP monitoring data typically includes the identity of web pages viewed by the user, and an indication of the time(s) that the user viewed the web pages (e.g., a timestamp(s)). In some examples, other formats and/or protocols may additionally or alternatively be monitored such as, for example, a HTTP Secure (HTTPS) protocol, a file transfer protocol (FTP), etc.

Web page complexity has increased to facilitate richer and/or more interactive experiences for viewers. In the past, a request for a web page (referred to herein as a “parent call”) received a text/html response which included text and may have contained additional image references (e.g., advertisements and/or pictures). Technologies such as Flash, JavaScript, and I-frames have made it easier for publishers to embed elements (e.g., advertisements, images, video, maps, music players, other ‘widgets’, etc.) in a webpage and/or to update content in one area of the webpage instead of refreshing the entire webpage. The proliferation of I-frames within websites, while allowing web page designers to embed the equivalent of a sub-page within a defined area, have led to an increase in text/html calls requesting subparts of the webpages as opposed to entire pages which makes it more difficult to identify the ‘parent call’ requesting a full webpage using HTTP traffic alone.

Web page elements (e.g., graphics, video, audio, text, etc.) displayed as part of a single web page may not originate from the same website that the user is viewing. For example, a single webpage (retrieved via the “parent call or request”) may display its own content simultaneously with content retrieved from one or more other webpages. The generation of such composite web pages results in additional web traffic (e.g., multiple HTTP requests) when a single web page is accessed. For example, in an email portal such as Gmail, yahoo, or Hotmail, in addition to displaying an electronic mail message, many additional web page elements may be returned, such as advertisements and widgets (e.g., news feeds, weather displays, etc.) Each advertisement may be provided by an entity other than the entity hosting the email portal. For example, an advertisement may be included within an I-Frame (retrieved from an advertisement network) that identifies a particular advertisement hosting entity.

In some examples, the parent webpage hosted by a web provider (e.g., a website) includes an I-frame or other Hypertext Markup Language (HTML) element that causes the client browser that made the parent call or request to request additional information from an intermediate provider (e.g., an advertising network) different from the web provider. Contents of the I-frame (retrieved from the intermediate provider) may instruct the browser to display an advertisement (e.g., an image, an animation, an Adobe flash element, etc.) that is hosted by an advertisement hosting entity (e.g., a content delivery network). The browser then requests and displays the advertisement from the hosting entity. As described herein, the web provider is credited with the display of the advertisement. Examples described herein enable association of web providers with advertisement networks as well as association of advertisement networks with advertisements. Understanding such associations enables Internet content providers to compare objective metrics related to different intermediate providers (e.g., advertising networks) such as, for example, identifying advertisement networks associated with other websites, identifying what advertisements are displayed as a result of instructions from different advertisement networks, etc.

Browsers provide information on the Universal Resource Locator (URL) of the page presently being accessed in the browser's Page Info interface. In addition to the URL, the Page Info interface may contain additional information about the page being presented such as, for example, an application type of the content being presented, a rendering mode of the content being presented, an encoding of the content being presented, a last modified data of the content being presented, media elements presented on the page, etc. The user may access the Page Info interface manually by clicking a Page Info control within the browser. The browser may then display the Page Info to the user via a dialog box. Of course, any other way of displaying information to the user may be implemented by the browser such as, for example, the Page Info may be displayed as a web page within the browser, the Page Info may be displayed within a system tray notification, etc. Alternatively, the Page Info interface may be accessed programmatically, for example via an Application Programming Interface (API).

In addition to Page Info, browsers typically provide information on the URL of individual media elements displayed by the browser as browser information. As described herein, browser information includes information related to elements of a webpage displayed by the browser such as, for example, a URL of an element displayed on the webpage, a file size of the element displayed on the webpage, a display size of the element displayed on the webpage, etc. In some examples, browser information is referred to as ad info, or frame info. In some examples, browser information is displayed and/or accessible via the Page Info interface. For example, Mozilla Firefox lists media elements displayed by the browser within the Page Info interface. In some examples, the browser information is not displayed and/or accessible via the Page Info Interface. Alternatively, the browser information may be retrieved via a properties interface. For example, Microsoft Internet Explorer does not provide information on the URL of individual media elements displayed via the Page Info interface and, instead, provides information on the URL of individual media elements displayed via the properties interface. Like the Page Info interface, the properties interface may be accessed programmatically via, for example, an API.

In example methods, apparatus, and articles of manufacture disclosed herein, Internet usage monitoring is accomplished by monitoring the Page Info interface and/or the properties of the browser and HTTP traffic data to identify associations of web providers and advertisement networks, and/or to identify advertisements displayed as a result of instructions from different advertisement networks.

Identifying associations of web providers with advertisement networks and/or identifying advertisements displayed as a result of instructions from different advertisement networks enables reporting of metrics related to different advertisement networks. By identifying what advertisement network caused what advertisement to be displayed, metrics can be provided to customers of advertising networks (e.g., companies that want to place advertisements) to enable those customers to compare different advertising networks.

For example, such metrics may include the overall reach or rating of the advertising network (e.g., a number of advertisement impressions caused by the advertisement network, a number of sites associated with the advertisement network, a number of advertisements associated with the advertisement network), statistics (e.g., an average, a mean, a maximum, a minimum, etc.) related to numbers of advertisement impressions per advertisement associated with the advertisement network, etc. Further, such metrics may include information about particular advertisements such as, for example, which advertisement networks an advertisement is associated with, is there advertisement overlap between different advertisement networks, how many times a particular advertisement network has caused an advertisement to be displayed, what websites a particular advertisement has been displayed on, etc. In some examples, the metrics under-represent the full reach and/or rating of an advertising network. To accommodate this, metrics generated by the example systems disclosed herein may be used as an input to a statistical model to enable more accurate representation of the overall reach and/or rating of advertising networks. Such a statistical model may incorporate information received from the advertisement network (e.g., a claimed number of advertisement impressions, etc.) to generate the metrics.

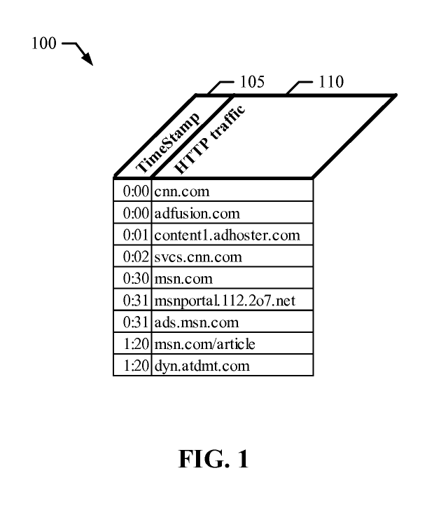

FIG. 1 illustrates a known transaction log of browsing events generated by a previous method for monitoring Internet media exposure. The transaction log 100 of FIG. 1 includes columns for a timestamp 105, and an HTTP traffic identifier 110. The timestamp column 105 of the example transaction log 100 shows the time that an HTTP event was detected. In the illustrated example, the timestamp represents a time after a start of a browsing session. In the example of FIG. 1, the timestamp column 105 is populated with data to indicate the amount of time that has passed since the start of the browsing session. However, the timestamp may alternatively be formatted as a time of day of the event (e.g., 3:00:00 PM, 3:03:40 PM, etc.) Further, the timestamp column 105 may additionally or alternatively include a date of the event.

The HTTP traffic column 110 is populated with HTTP traffic data representing HTTP traffic at the time of the HTTP event. In the illustrated example, detection of an event (e.g., HTTP traffic) causes the generation of the timestamp. Thus, the timestamps may be thought of as a timestamp of the detected event (e.g., an HTTP request) identified in the traffic column 110. As shown in the illustrated example, at 0:00 the user requested data from cnn.com. In response to the user's request for data from cnn.com, the browser subsequently requested information from adfusion.com (at 0:00), content1.adhoster.com (at 0:01), and svcs.cnn.com (at 0:02). The close proximity in time of the timestamps indicates that these requests were all part of the same transaction. Thus, although the user is likely to have requested the cnn.com webpage initially, the subsequent requests were likely automatic requests driven by the cnn.com webpage itself. Although a specific set of web sites are shown in the transaction log 100 to illustrate a prior method, any web sites could be included in the transaction log 100, because the contents of the transaction log are dependent upon the activity of the user and the contents of requested web pages.

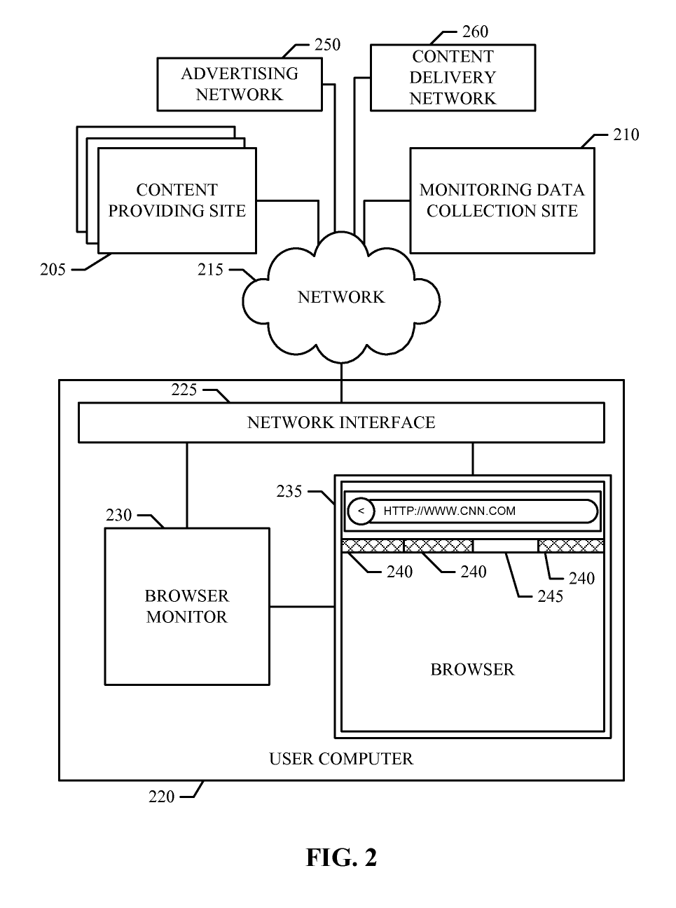

FIG. 2 is a block diagram of an example system to monitor usage of an Internet advertising network. The example monitoring system includes a browser monitor 230 and a monitoring data collection site 210. The example monitoring system of FIG. 2 is shown in an example environment of use including a content providing site 205, a network 215, a user (e.g., a client) computer 220, an advertising network 250, and a content delivery network 260. In the illustrated example, the user computer 220 includes a network interface 225 and executes the browser monitor 230, and a browser 235. The browser 235 of the illustrated example includes inactive browser tabs 240 and an active browser tab 245. The example content providing site 205 is a server or group of servers that provides content to the browser 235 in response to an HTTP request. There may be multiple content providing sites 205 identified by different Internet Protocol (IP) addresses and serving different content. For example, in a single session it is likely that a browser will communicate with multiple content providing sites 205. For example, in a single browser session a user may check their email from a first site 205, read a news article served or hosted by a second site 205, check the weather from a third site 205, and watch a video or Internet Protocol Television (IPTV) content from a fourth site 205. The content provider sites 205 may be linked, wherein content from one site is displayed on another site as part of a composite webpage. For example, an email portal content provider site may have a weather widget displaying weather data from a weather content provider site in a window or other portion of a webpage simultaneously displaying the email content.

In the example of FIG. 2, the monitoring data collection server 210 is a site to which the browser monitor 230 of the user computer 220 reports data. In the illustrated example, the collection site is a neutral third party site (e.g., operated by The Nielsen Company (US) LLC) that does not provide the monitored content from server 205 to client devices 220 and is not involved with delivering content from the content servers 205 to the client device 220. The monitoring data collection site 210 may be associated with an audience measurement and/or web analytics company whose un-involvement with the content delivery ensures its neutral status and, thus, enhances the trusted nature of the data it collects. The monitoring data collection site 210 may receive data in any fashion. In the illustrated example, monitoring data is transmitted from the browser monitor 230 to the monitoring data collection site 210 by File Transfer Protocol (FTP) communication. Any other system or protocol for transmitting data may additionally or alternatively be used. For example, the data may be transmitted by an HTTP GET request, wherein the request includes the collected data, or via some other data transfer or transmission protocol. The monitoring data collection site 210 may process the monitoring data before storing the data, or it may store the data as it is received. Although for simplicity, only one browser monitor 230 is shown in FIG. 2, the monitoring data collection site 210 may collect data from multiple browser monitors 230 monitoring multiple client/user computers 220.

The network 215 of the illustrated example is the Internet. However, any other network could be used. For example, some or all of the network 215 may be a company's intranet network, a personal (e.g., home) network, etc. Although the network 215 of the illustrated example operates based on the HTTP and IP protocols, the network 215 may additionally or alternatively use any other protocol to enable communication between devices on the network.

The user computer 220 of the illustrated example is a personal computer. However, any other type of computing device could be used to implement the computer 220 such as, for example, a mobile (e.g., cellular) phone, a personal digital assistant (PDA), Internet appliance, a tablet (e.g., an Apple® iPad®, etc.,) etc. The user of the illustrated example is a panelist who has agreed to participate in a study. Although the example system of FIG. 2 is a panelist-based system, other non-panelist and/or hybrid panelist/non-panelist systems may be employed. In the panelist system of the illustrated example, demographic information is obtained from the user when the user joins and/or registers for the panel. The demographic information may be obtained from the user via a telephone interview, by having the user complete a survey (e.g., an online survey), etc.

The network interface 225 is an interface that allows applications running local to the computer 220 to communicate with external sites via the network 215. In the illustrated example, the network interface 225 is a wired Ethernet port. However, any other type of network interface may be used. For example, a WiFi 802.11x wireless network port, a Bluetooth network adapter, or a cellular modem may be used. Additionally or alternatively, there may be multiple network interfaces in any combination of one or more types.

The browser monitor 230 of the illustrated example monitors user activity on the computer 220, and more specifically monitors user interaction with the browser 235. In the illustrated example, the browser monitor 230 is an application executed on the computer 220. The application is downloaded to the computer 220 upon receiving user consent. The consent may be obtained via the registration process (e.g., when the user is interviewed to join the panel, when the user completes an online survey to join the panel, etc.) The application may be downloaded via the Internet or sent to the user via a compact disc (CD), a digital versatile disc (DVD), a Blu-ray disc, a universal serial bus (USB) flash drive, and/or any other computer-readable medium(s) storing the machine-readable instructions that constitute the application. However alternative architectures or implementations may also be employed such as, for example, embedding the browser monitor in the browser 235 (e.g., a browser plug-in, JavaScript, etc.), monitoring browser activity from a remote site such as the monitoring data collection site 210, etc.

In the illustrated example, browser 235 presents web content to the user. The example browser of FIG. 2 is a tabbed browser. Tabbed browsers allow the user to download multiple web pages and select between the pages using tabs. For example, the user is presented with a first web page on a first tab, a second web page on a second tab, etc. Only one of the web pages is displayed (i.e., active) at a given time (i.e., the page associated with the active tab). The other pages (inactive pages) associated with the inactive tabs are stored or cached for later viewing. The tab associated with the currently displayed web content is known as the active browser tab 245, while tabs associated with currently non-displayed web content are known as inactive browser tabs 240. In the illustrated example, the browser 235 is Mozilla Firefox®. However, any other tabbed browser may also be used such as, for example, Microsoft Internet Explorer®, Apple Safari®, Google Chrome™, etc. Further, the browser 235 may be implemented by an application other than a traditional browser application such as, for example, an application hosting an HTML viewer, a desktop browser (e.g., a Windows 8-style user interface), etc. At any given time, there may be one or any number of browser tabs instantiated in a browser. The browser tabs that are associated with content but are not currently displayed and/or selected are considered inactive browser tabs 240.

While the example of FIG. 2 illustrates only one client device 220, multiple client devices 220 (each monitored by a separate browser monitor 230) are present in some examples. The client devices 220 may be associated with different panelists, households, locations, and/or groups of panelists (e.g., a family). Similarly, while FIG. 2 illustrates one collection site 210, more than one collection site 210 may be employed and/or the collection site 210 may be organized into hierarchical and/or geographic regions.

The advertising network 250 of the illustrated example of FIG. 2 is an online advertisement publisher. Advertising networks are used to connect companies that want to place advertisements with website hosters that want to display advertisements. Many different advertising networks exist, and selecting an advertising network to partner with can be difficult from both an advertiser perspective and a website hoster perspective. Advertisers seek information concerning which website(s) their advertisements will be displayed on. Website hosters seek information concerning which advertisements will be displayed on their website(s).

Advertising networks routinely vary the advertisements displayed on a given webpage. For example, when a page is displayed, a first advertisement may be displayed. However, when the page is refreshed, a second advertisement different from the first advertisement may be displayed even if the rest of the content of the webpage is unchanged. Further, some advertising networks seek to display advertisements on websites where it is more likely that the advertisement will be clicked. For example, an advertising network may identify a demographic that typically visits a particular website and display advertisements that the demographic is likely to be interested in on such a website. For example, an advertisement network selecting advertisements to be displayed on a technology blog might select an advertisement for a technological product, rather than an advertisement for real estate. For both the advertiser and the website hoster, understanding which advertisements are selected for display by the advertising network may be an important factor in selecting an advertising network to partner with.

The content delivery network 260 of the illustrated example of FIG. 2 is one or more servers that serve content via the network 215 to end users. In some examples, content delivery networks are geographically distributed to reduce network delay associated with distributing content over a network such as the Internet. Reducing network delay associated with distributing content to an end user results in an enhanced browsing experience for the user. In some examples, content delivery networks are operated by Internet service providers and may cache Internet content for delivery to subscribers. If, for example, a user was to request content from a content delivery network operated by an Internet service provider, the request for the content, and the response including the content would traverse the network to reach the content delivery network hosted by the Internet service provider, rather than a server outside of the Internet service provider. Such a topology reduces bandwidth requirements and/or reduces communication delay because requests and/or responses received and/or transmitted by the content delivery network operated by the Internet service provider do not leave the Internet service provider's network.

In the case of advertisements, reducing network delay increases the probability that an advertisement will be displayed to the user in a timely manner. If an advertisement is not displayed in a timely manner, the user may click on a different link and/or not see the advertisement. Advertisers and advertising networks seek to give users the opportunity to view the advertisements they intend to have displayed. Not displaying an advertisement because of content delivery delays does not achieve such a goal. Accordingly, advertising networks routinely utilize content delivery networks to deliver advertisements to end users.

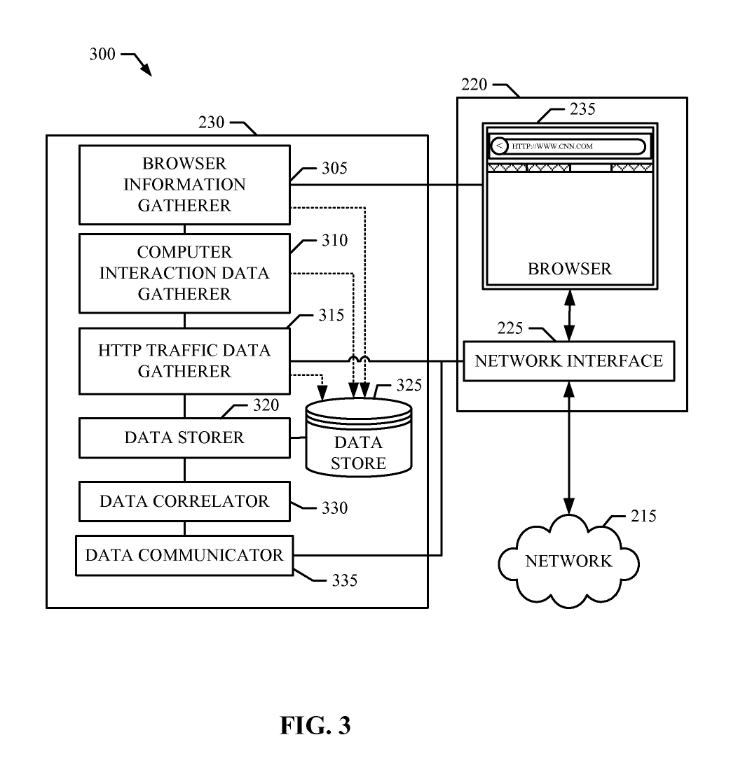

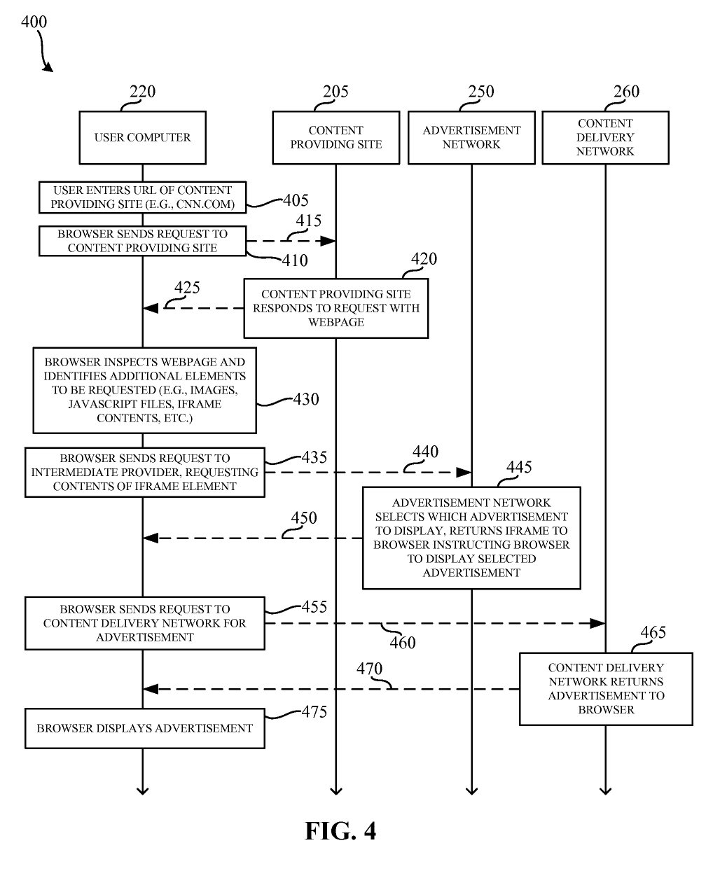

FIG. 3 is a block diagram of the example browser monitor of FIG. 2. The example browser monitor 230 includes a browser information gatherer 305, a computer interaction data gatherer 310, a Hypertext Transfer Protocol (HTTP) traffic data gatherer 315, a data storer 320, a data store 325, a data correlator 330, and a data communicator 335. The browser information gatherer 305 gathers browser information from the browser 235. The browser information includes browser properties and currently displayed data. In the illustrated example, the browser information gatherer 305 collects Page Info data from the browser. However, other data may also be gathered from the browser such as, for example, information on the active tab of the browser, user interaction information, browser cookies, installed plug-ins, etc. The example Page Info data shown in FIGS. 4 and/or 5 contains the address of the page being displayed, the type of the page being displayed, the encoding of the page being displayed, etc. The information on the active tab of the browser may include the status of the active tab, the position of the tab, and the number of tabs open within the browser. However, any other information related to the browser 235 may additionally and/or alternatively be collected.

The computer interaction data gatherer 310 gathers data related to user interactions with the computer 220. In the illustrated example, the computer interaction data includes events associated with the mouse and keyboard (e.g., mouse clicks, mouse movements, keystrokes, trackball movements, track pad movements, etc.), as well as information about whether the browser 235 was in focus. However, any other data of interest may be gathered such as, for example, a list of other applications that are being executed, software versions of applications installed on the computer, focus status of other applications that are being executed, etc. In the illustrated example, events are collected by monitoring operating system events (e.g., via a keyboard and/or mouse hook). However, any other methods of monitoring operating system events may additionally or alternatively be used such as, for example, monitoring operating system files, monitoring operating system calls, monitoring memory accesses, using an operating system API, etc.

The HTTP traffic data gatherer 315 of the illustrated example gathers HTTP traffic data sent and/or received by the user computer 220. In the illustrated example, the HTTP traffic data gatherer 315 gathers clickstream data by monitoring the network interface 225 for HTTP requests and responses. Additionally or alternatively, HTTP traffic data may be gathered directly from the browser via a browser plug-in that records network traffic. The example HTTP traffic data gatherer 315 filters HTTP traffic based on a library of terms of interest so that only items matching a specific type (e.g., messages including an HTTP reply) are recorded. However, the HTTP traffic data gatherer 315 may additionally or alternatively collect/record all HTTP traffic or may use some other sort of filter. In the illustrated example, HTTP traffic data includes any message from one computer to another. Such messages often include a Universal Resource Locator (URL). Additionally or alternatively, the HTTP traffic data may include data identifying the originating software application. For example, the HTTP traffic data may indicate that the originating software application is a word processing application requesting updates from a server via an HTTP request. In that case, the HTTP traffic data gatherer 315 of some examples will disregard the HTTP traffic, as it does not relate to user interaction with a browser. While in the illustrated example, the HTTP traffic data gatherer 315 identifies HTTP traffic, any other traffic may additionally or alternatively be monitored such as, for example File Transfer Protocol (FTP) traffic, HTTP Secure (HTTPS) traffic, etc.

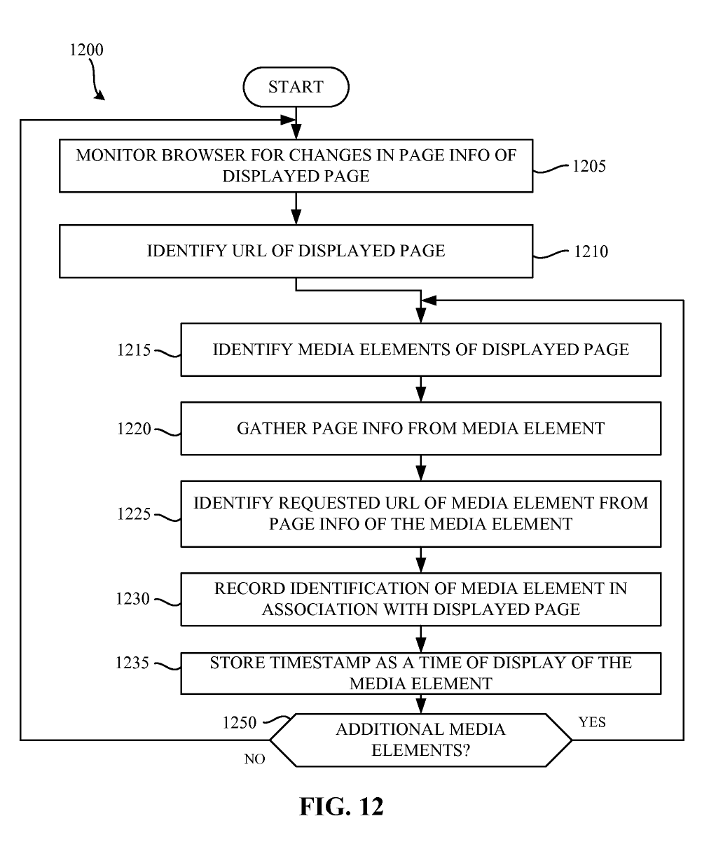

The example data storer 320 of FIG. 3 is implemented by hardware (e.g., a processor such as the processor 1200 of FIG. 12) executing instructions, but it could alternatively be implemented by an Application Specific Integrated Circuit (ASIC), Digital Signal Processor (DSP), Field Programmable Gate Array (FPGA), or other logic circuit. The data storer 320 receives monitoring data from the browser information gatherer 305, the computer interaction data gatherer 310, and/or the HTTP traffic data gatherer 315, and stores the data in the data store 325. The data store 325 may be implemented by any device and/or medium for storing data such as, for example, solid-state memory, flash memory, magnetic media such as a hard disk drive, random access memory, optical media such as a compact disc (CD), a digital versatile disc (DVD), or a Blu-ray disc, etc. Furthermore, the data stored in the data store 325 may be in any data format such as, for example, binary data, comma delimited data, tab delimited data, structured query language (SQL) structures, etc.

The example data correlator 330 of FIG. 3 is implemented by hardware (e.g., a processor) executing instructions, but it could alternatively be implemented by an ASIC, DSP, FPGA, or other logic circuit. The data correlator 330 parses the data stored in the data store 325 by the data storer 320 to determine which websites were viewed and/or how long each of the web sites were viewed. In the illustrated example, the data correlator 330 uses HTTP traffic data, mouse and keyboard data, application focus data, and active tab data to determine what web site a user was presented, and how long the web site was presented. Further, the data correlator 330 may store additional data in the data store 325 such as, for example, classification data and/or crediting data. Although the example of FIG. 3 illustrates the data correlator 330 as a component of the browser monitor 230, in some examples, the data correlator 330 may be a component of the data collection site 210.

The example data communicator 335 of FIG. 3 is implemented as an Ethernet interface. However, any other method of implementing the data communicator could alternatively be used. For example, the data communicator 335 may represent a TCP/IP stack. The data communicator communicates with the monitoring data collection site 210 to report the monitoring data collected by the browser monitor 230.

FIG. 4 is a communication diagram 400 illustrating example requests made for retrieving elements to be displayed as part of an example webpage. In the illustrated example, a user instructs the browser 235 of the user computer 220 to retrieve and display a webpage (e.g., cnn.com) (block 405). Upon receiving the instruction to display the webpage, the browser 235 sends a request (arrow 415) to the domain specified by the user (block 410). In the illustrated example, the request (arrow 415) requests a file (e.g., a webpage) hosted by the content providing site 205. The content providing site 205 responds to the received request with the requested file (e.g., the webpage) (block 420, arrow 425). In some examples, the content providing site 205 may instruct the browser 235 to retrieve and/or display elements (e.g., images, animations, Cascading Style Sheet (CSS) files, JavaScript files, webpages, etc.) other than the returned page. For example, the content providing site 205 may return a redirect instruction, the content providing site 205 may return a webpage that includes links to other elements (e.g., the images, the animations, the CSS files, the JavaScript files, the webpages, monitoring instructions in accordance with Blumenau, U.S. Pat. No. 6,108,637, etc.), etc.

The browser 235 inspects the received file and identifies any additional elements that are to be retrieved to display the webpage (block 430). In the illustrated example, an iframe element is included in the webpage and has a source attribute of the advertisement network 250. Accordingly, the browser sends a request (arrow 440) to the advertisement network 250 (block 435) requesting the content of the iframe element. In the illustrated example, the request is an HTTP GET request. However, any other format and/or type of request may additionally or alternatively be used. In some examples, the request indicates a referrer. The referrer identifies a host of the element that caused the browser to request the content for the iframe from the advertisement network 250. Additionally, other information may be transmitted as part of the request such as, for example, an identifier of the webpage that caused the request, an identifier of the user, etc. Based on the request, the advertisement network 250 selects which advertisement should be displayed (block 445), and returns a link to the selected advertisement to the browser as the content of the iframe (arrow 450). In the illustrated example, the link to the selected advertisement indicates that the advertisement is hosted by the content delivery network 260. In some examples, the advertisement is hosted by a different provider such as, for example, the advertisement network 250.

Having received the link to the advertisement that is to be displayed as part of the iframe, the browser automatically (i.e., without user involvement) sends a request (arrow 460) to the content delivery network 260 for the advertisement (block 455). In the illustrated example, the request is an HTTP GET request. However, any other format and/or type of request may additionally or alternatively be used. In the illustrated example, the HTTP request indicates that the referrer is the advertisement network 250. The content delivery network 260 then returns the requested advertisement to the browser (block 465) as a reply (arrow 470). Having received the advertisement, the browser 235 proceeds to display the advertisement (block 475).

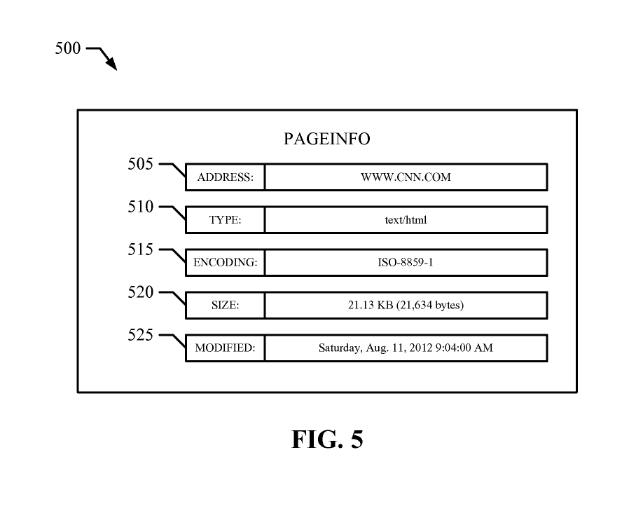

FIG. 5 is a diagram of example Page Info data 500. The example Page Info data 500 is collected from the browser 235 by the example browser monitor 230 of FIG. 2, and includes an address field 505, a content type field 510, a content encoding field 515, a content size field 520, and a modified date field 525. Additional and/or alternative fields may be included in the Page Info data 500 such as, for example, a metadata field, page rendering type fields, a page title field, etc. The browser 235 derives the fields from the HTTP message of the received web content. Although the illustrated example employs the HTTP header specification (RFC 2616) to derive some or all of the fields of the Page Info data 500 from the HTTP header of the HTTP message, any past, present, or future standards may be employed. The address field 505 describes the address of the page currently being displayed by the browser 235. In the illustrated example, the address field 505 is derived from the host field of the HTTP header of the received web content. By monitoring the address field 505 of the Page Info data 500, the example browser monitor 230 of FIG. 2 determines what website the parent call identifies (instead of relying on HTTP traffic to predict and/or infer what is being displayed.) The content type field 510 describes the application type of the content being displayed (e.g., content types include text/plain, text/html, multipart/alternative, etc.) The encoding field 515 indicates the type of encoding used for the webpage. Currently available encoding types include ISO-8859-1 and UTF-8, but any other encoding type may additionally or alternatively be used. The content size field 520 indicates the size of the web page being displayed by the browser 535. The content size field 520 can be any value, and is dependent on the particular content being presented. The modified date 525 shows the last time that the page being displayed was modified. In the illustrated example, the web page served by www.cnn.com has a content type 510 of text/html, a content encoding 515 of ISO-8859-1, a content size 520 of 21.13 KB, and was last modified 525 on Saturday, Jul. 28, 2012.

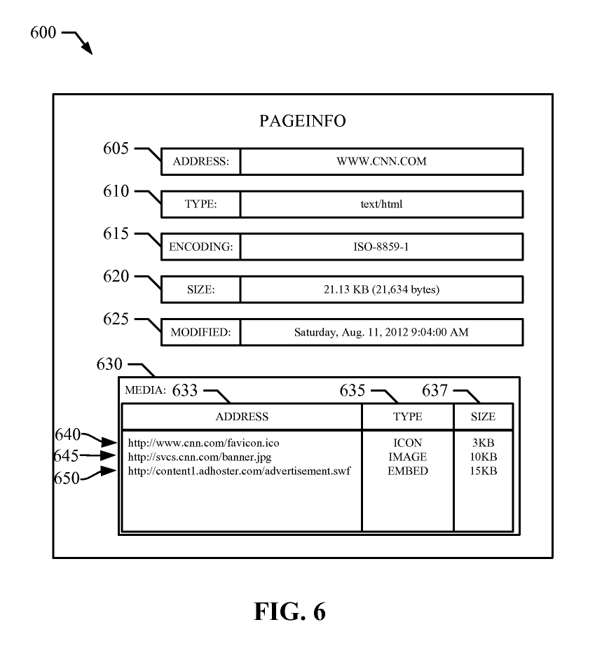

FIG. 6 is a diagram of an alternate example of Page Info data 600. As described in connection with FIG. 5, additional information may be displayed via the Page Info interface of the browser 235. The example Page Info data 500 of FIG. 5 includes an address field 605, a content type field 610, a content encoding field 615, a content size field 620, and a modified date field 625 that correspond to the address field 505, the content type field 510, the content encoding field 515, the content size field 520, and the modified date field 525 of FIG. 5, respectively. Further, the example Page Info data 600 of FIG. 6 includes media information 630. The media information 630 includes information corresponding to media elements displayed by the browser. In the illustrated example, the media information 630 identifies an address 633, a content type 635, and/or a size 637 of the media elements displayed on the page. In the illustrated example, three media elements are displayed in connection with the page retrieved from www.cnn.com. However, any number of media elements may additionally or alternatively be displayed as, for example, the number of media elements is dependent on the web page being displayed. In the illustrated example an icon 640, an image 645, and a flash element 650 are displayed in connection with the page retrieved from www.cnn.com. However, any other types of media elements having any other address may additionally or alternatively be used.

In some examples, the browser 235 provides Page Info information similar to what is shown in FIG. 5, while in other examples the browser 235 provides Page Info information similar to what is shown in FIG. 6. In examples where the browser 235 does not provide the media information 630 similar to what is shown in FIG. 6, the browser 235 may provide similar media information via a different interface such as, for example, a properties interface. Accordingly, information related to media elements may be retrieved from a Page Info interface of the browser 235 or from a separate interface provided by the browser.

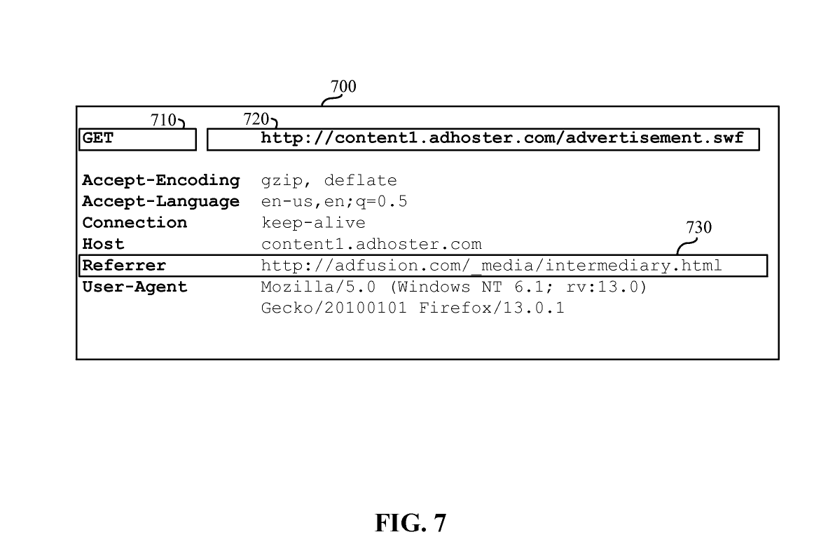

FIG. 7 illustrates an example hypertext transfer protocol (HTTP) request header 700. In the illustrated example, the HTTP header 700 includes a method 710, a destination 720, and a referrer 730. In the illustrated example, the method 710 is a GET method. However, any other HTTP method may alternatively be used such as, for example, a HEAD method, a POST method, etc. In the illustrated example, the HTTP request header 700 represents a request for an advertisement file hosted at the destination 720 content1.adhoster.com/advertisement.swf. However, any other destination 720 may additionally or alternatively be used. In the illustrated example, content1.adhoster.com represents the content delivery network 260. The referrer 730 identifies the page that caused the browser to issue the HTTP request. In some examples, the referrer 730 may be blank and/or may be omitted from the HTTP request header 700. For example, the referrer 730 may be blank and/or omitted when the user navigates to the page without using a hyperlink (e.g., when the user enters the requested address into an address bar of the browser, when the user instructs the browser to go to a bookmark, etc.). However, in many examples the referrer field represents a Universal Resource Locator (URL) of the element that caused the browser to make the request. As described in connection with FIG. 4, when the browser receives a webpage from the content providing site 205 (arrow 425), the browser inspects the webpage and identifies additional elements to be requested. In the illustrated example of FIG. 4, an iframe element causes the browser 235 to request the contents of the iframe from the advertisement network 250 (block 432, arrow 440). The request identifies the webpage provided by the content providing site 205, because the webpage caused the browser to make the request to the advertisement network 250.

In the illustrated example, the referrer 730 for the request 700 is adfusion.com/_media/intermediary.html. In the illustrated example, adfusion.com represents the advertisement network 250. Accordingly, the request 700 indicates that the advertisement network 250 instructed the browser 230 to display an advertisement stored at the content delivery network 260. (A similar example request is represented by arrow 460 of FIG. 4.) When inspecting the HTTP request header 700 alone, it is difficult to determine what page the advertisement was displayed with. When inspected in conjunction with Page Info data retrieved from the browser (e.g., FIG. 5 and/or FIG. 6), it is possible to identify what advertisement was displayed on what page, and it is also possible to identify what advertisement network was used to display the advertisement (based on the referrer 730 of the request 700 for the advertisement). Such additional information is useful to advertisers when attempting to determine which advertising networks their advertisements should be displayed through, and is also useful to website operators when attempting to determine which advertising networks should display advertisements on their website.

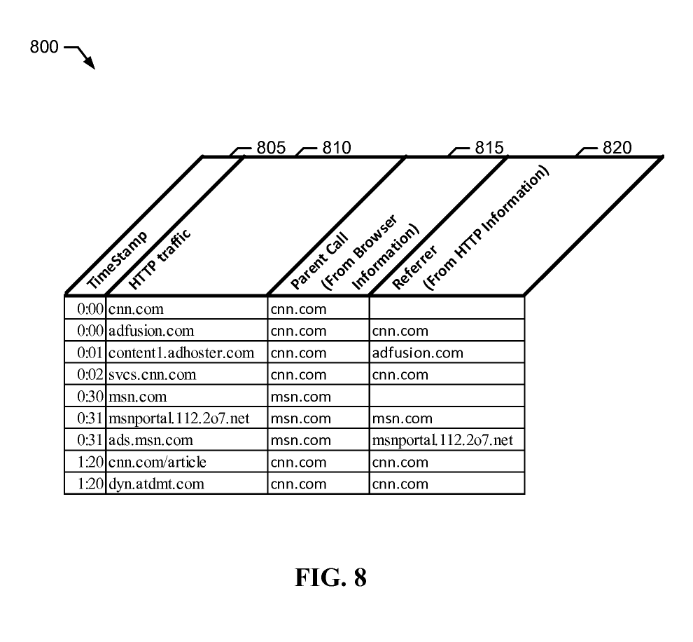

FIG. 8 illustrates an example enhanced transaction log 800 of browsing events generated by the example data correlator 330. In the illustrated example, the log includes associations of the requested Universal Resource Locators (URLs) with parent URLs and referrer URLs. The example enhanced transaction log 800 of FIG. 8 represents the transaction log 100 of FIG. 1 with added information. The example enhanced transaction log 800 of FIG. 8 includes columns for a timestamp 805, an HTTP traffic identifier 810, a parent call identifier 815, and a referrer identifier 820. The timestamp column 805 of the example enhanced transaction log 800 shows the time that an HTTP event was detected. In the illustrated example, the timestamp represents a time after a start of a browsing session. In the example of FIG. 8, the timestamp column 805 is populated with data to indicate the amount of time that has passed since the start of the browsing session. However, the timestamp may alternatively be formatted as a time of day of the event (e.g., 3:00:00 PM, 3:03:40 PM, etc.) Further, the timestamp column 805 may additionally or alternatively include a date of the event.

The HTTP traffic column 810 is populated with HTTP traffic data representing HTTP traffic at the time of the HTTP event. In the illustrated example, detection of an event (e.g., HTTP traffic) causes the generation of the timestamp. Thus, the timestamps may be thought of as a timestamp of the detected event (e.g., an HTTP request) identified in the traffic column 810. As shown in the illustrated example, at 0:00 the user requested data from cnn.com. In response to the user's request for data from cnn.com, the browser additionally requested information from adfusion.com (at 0:00), content1.adhoster.com (at 0:01), and svcs.cnn.com (at 0:02). The close proximity in time of the timestamps typically indicates that these requests were all part of the same transaction. However, because multiple browser tabs may be opened at the same time (e.g., the user might open a tab for cnn.com as well as a tab for msn.com), relying on timestamp data alone to associate HTTP traffic with a parent call does not provide accurate results. By inspecting Page Info data (as shown in FIGS. 5 and/or 6), it is possible to identify which HTTP requests were associated with a particular page. The Page Info data identifies elements displayed on a webpage by their URL. Using the URL of a displayed element, the data correlator 330 can identify an HTTP request for that element based on the URL. Although a specific set of web sites are shown in the example enhanced transaction log 800, any web sites could be included in the enhanced transaction log 800, because the contents of the transaction log are dependent upon the activity of the user and the contents of requested web pages.

The parent call column 815 represents parent call information retrieved from the Page Info interface shown in FIGS. 5 and/or 6. In the illustrated example, between times 0:00 and 0:02, each of the identified HTTP traffic events has a parent call of cnn.com. This represents that each of the HTTP traffic events was associated with the page displayed as a result of instructions received from cnn.com.

The referrer column 820 represents referrer information retrieved from HTTP headers associated with the HTTP traffic events. In the illustrated example, the HTTP header is similar to the HTTP header 700 shown in FIG. 7. In the illustrated example, the HTTP traffic event at 0:01 to content1.adhoster.com is represented by the HTTP request 700 of FIG. 7. The referrer field 730 of FIG. 7 identifies that the HTTP request 700 was caused by adfusion.com, which is represented in the referrer column 820; and that the HTTP request 700 was directed to content1.adhoster.com, which is represented in the HTTP traffic column 810. Using the HTTP header 700 to associate the HTTP request with media elements associated with a web page enables the association of advertisements with advertisement networks (e.g., the advertisement network 250), and websites (e.g., the content providing site 205) with various advertisement networks.

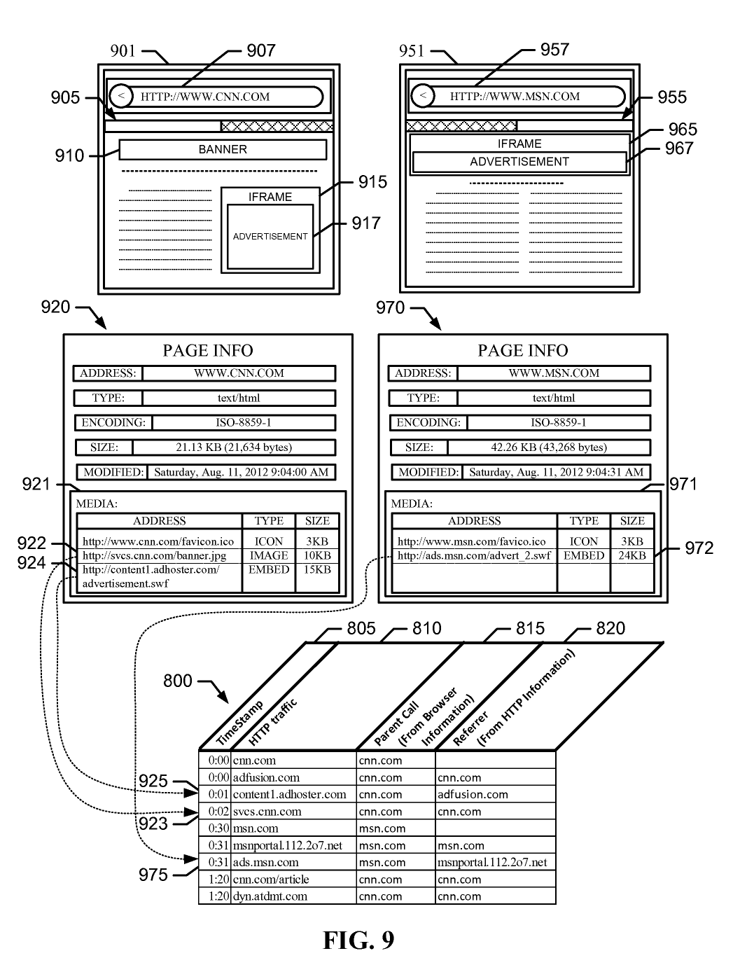

FIG. 9 is a diagram illustrating how example elements identified by Page Info data from multiple browser tabs may be associated with HTTP request headers. In the illustrated example of FIG. 9, a browser 901, 951 is shown. While in the illustrated example the browser 901, 951 represents the same browser, the browser 901, 951 is shown twice to illustrate two websites open in separate tabs 905, 955 of the browser. In the first example of the browser 901, a first tab 905 is selected. The first tab corresponds to an address 907 of an Internet resource (e.g., the content providing site 205). In the illustrated example, the address corresponds to www.cnn.com. However any other address may additionally or alternatively be used. The webpage displayed at the address 907 includes a banner 910 and an iframe 915. The iframe 915 includes an advertisement 917.

In the second example of the browser 951, a second tab 955 is selected. The second tab 955 corresponds to an address 957 of an Internet resource (e.g., the content providing site 205). In the illustrated example, the address corresponds to www.msn.com. However any other address may additionally or alternatively be used. The webpage displayed at the address 957 includes an iframe 965. The iframe 965 includes an advertisement 967.

Example Page Info interfaces 920, 970 are shown in FIG. 9 that correspond to webpages displayed within the example browser tabs 905, 955. The first example Page Info interface 920 corresponds to the webpage displayed when the first browser tab 905 is selected. The media section 921 of the example Page Info interface 920 lists elements displayed by the browser 901. In the illustrated example, element 922 corresponds to the banner 910 displayed as part of the webpage. Element 924 corresponds to the advertisement 917 displayed as part of the webpage. The second example Page Info interface 970 corresponds to the webpage displayed when the second browser tab 955 is selected. The media section 971 of the example Page Info interface 970 lists elements displayed by the browser 951. In the illustrated example, element 972 corresponds to the advertisement 967.

In the illustrated example of FIG. 9, the element 924 has an address of content1.adhoster.com/advertisement.swf. Based on the address of the element 924 and the Page Info, it is possible to determine that this advertisement was displayed on cnn.com. Similarly, it can be determined that element 972 was displayed as part of msn.com based on the Page Info interface 970. However, this information does not identify the advertisement network that caused the display of the advertisement(s).

When the address and/or URL of the elements displayed as part of the websites are correlated with network traffic as shown in the example enhanced transaction log 800 of FIG. 8, the referrer address can be identified. Based on the address and/or URL of element 922, the element 922 can be associated with line item 923 of the enhance transaction log 800. Line item 923 indicates that the referrer for the banner 910 was cnn.com. Element 924 can be associated with line item 925 of the enhance transaction log 800 based on the address and/or URL of element 924 from the Page Info interface 920. Line item 925 indicates that the referrer for the advertisement 915 was adfusion.com. Based on this information, the advertisement 915 and/or the website it was displayed as a part of (e.g., www.cnn.com) can be associated with the advertisement network adfusion.com. Similarly, Element 974 can be associated with line item 975 of the enhance transaction log 800 based on the address and/or URL of element 974 from the Page Info interface 970. Line item 975 indicates that the referrer for the advertisement 967 was msnportal.112.2o7.net. Accordingly, the advertisement 967 and/or the website it was displayed as a part of (e.g., msn.com) can be associated with the advertisement network 112.2o7.net. As described above, associations of advertisements with advertisement networks and/or websites with advertisement networks can be used to generate comparative metrics among the different advertisement networks. As described herein, multiple webpages that are displayed by separate browser tabs at substantially the same time can be distinguished because media elements displayed as part of the webpages will only appear on the associated Page Info interface. In some examples, the browser exposes a single Page Info interface that corresponds to the actively displayed window. Accordingly, the Page Info interface may monitored to identify what website is presently displayed.

While an example manner of implementing the browser monitor 230 of FIG. 2 has been illustrated in FIG. 3, one or more of the elements, processes and/or devices illustrated in FIG. 3 may be combined, divided, re-arranged, omitted, eliminated and/or implemented in any other way. Further, the example browser information gatherer 305, the example computer interaction data gatherer 310, the example HTTP traffic data gatherer 315, the example data storer 320, the example data store 325, the example data correlator 330, the example data communicator 335, and/or, more generally, the example browser monitor 230 of FIGS. 2 and/or 3 may be implemented by hardware, software, firmware and/or any combination of hardware, software and/or firmware. Thus, for example, any of the example browser information gatherer 305, the example computer interaction data gatherer 310, the example HTTP traffic data gatherer 315, the example data storer 320, the example data store 325, the example data correlator 330, the example data communicator 335, and/or, more generally, the example browser monitor 230 of FIGS. 2 and/or 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example browser information gatherer 305, the example computer interaction data gatherer 310, the example HTTP traffic data gatherer 315, the example data storer 320, the example data store 325, the example data correlator 330, and/or the example data communicator 335 are hereby expressly defined to include a tangible computer-readable medium such as a memory, DVD, CD, Blu-ray, etc. storing the software and/or firmware. Further still, the example browser information gatherer 305, the example computer interaction data gatherer 310, the example HTTP traffic data gatherer 315, the example data storer 320, the example data store 325, the example data correlator 330, the example data communicator 335 of FIG. 3 may include one or more elements, processes and/or devices in addition to, or instead of, those illustrated in FIG. 4, and/or may include more than one of any or all of the illustrated elements, processes and devices.

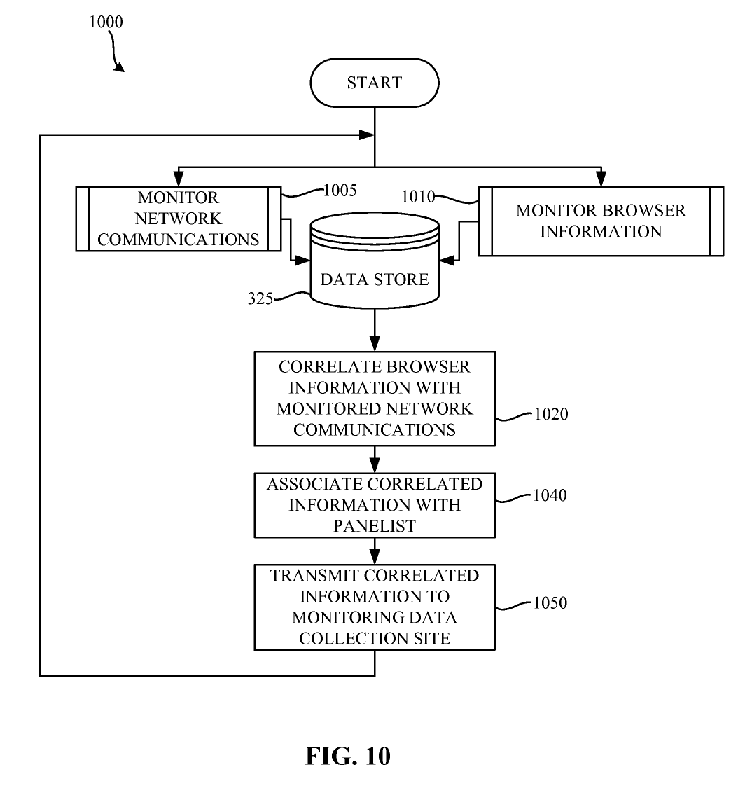

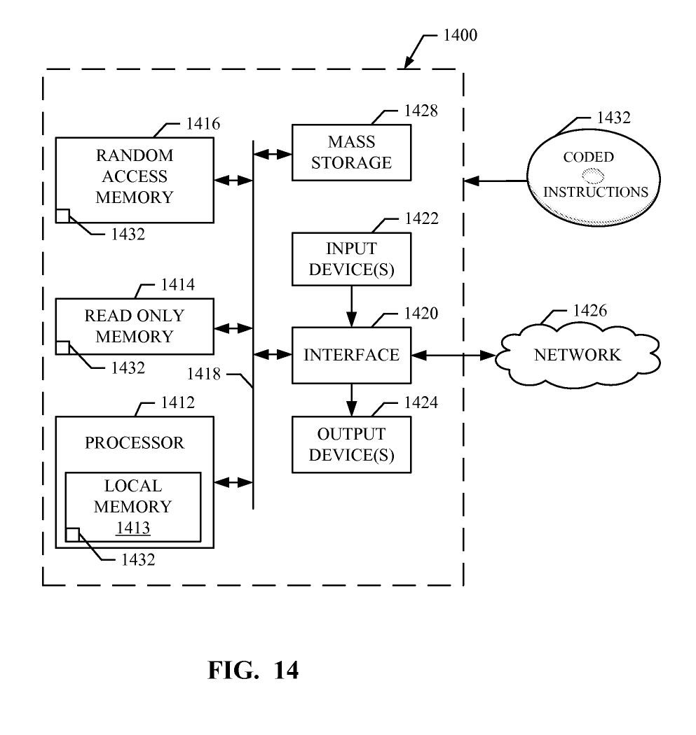

Flowcharts representative of example machine-readable instructions for implementing the browser monitor 230 of FIGS. 2 and/or 3 is shown in FIGS. 10, 11, 12, and/or 13. In these examples, the machine-readable instructions comprise programs for execution by a physical hardware processor such as the processor 1412 shown in the example processor platform 1400 discussed below in connection with FIG. 14. A processor is sometimes referred to as a microprocessor or a central processing unit (CPU). The program may be embodied in software stored on a tangible computer-readable medium such as a CD-ROM, a floppy disk, a hard drive, a digital versatile disk (DVD), a Blu-ray disk, or a memory associated with the processor 1412, but the entire program and/or parts thereof could alternatively be executed by a device other than the processor 1412 and/or embodied in firmware or dedicated hardware. Further, although the example program is described with reference to the flowchart illustrated in FIGS. 10, 11, 12, and/or 13, many other methods of implementing the example browser monitor 230 may alternatively be used. For example, the order of execution of the blocks may be changed, and/or some of the blocks described may be changed, eliminated, or combined.

As mentioned above, the example processes of FIGS. 10, 11, 12, and/or 13 may be implemented using coded instructions (e.g., computer-readable instructions) stored on a tangible computer-readable medium such as a computer-readable storage medium (e.g., a hard disk drive, a flash memory, a read-only memory (ROM), a compact disk (CD), a digital versatile disk (DVD), a cache, a random-access memory (RAM)) and/or any other storage medium in which information is stored for any duration (e.g., for extended time periods, permanently, brief instances, for temporarily buffering, and/or for caching of the information). As used herein, the term tangible computer-readable medium is expressly defined to include any type of computer-readable storage medium and to exclude propagating signals. Additionally or alternatively, the example processes of FIGS. 10, 11, 12, and/or 13 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer-readable medium is expressly defined to include any type of computer-readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

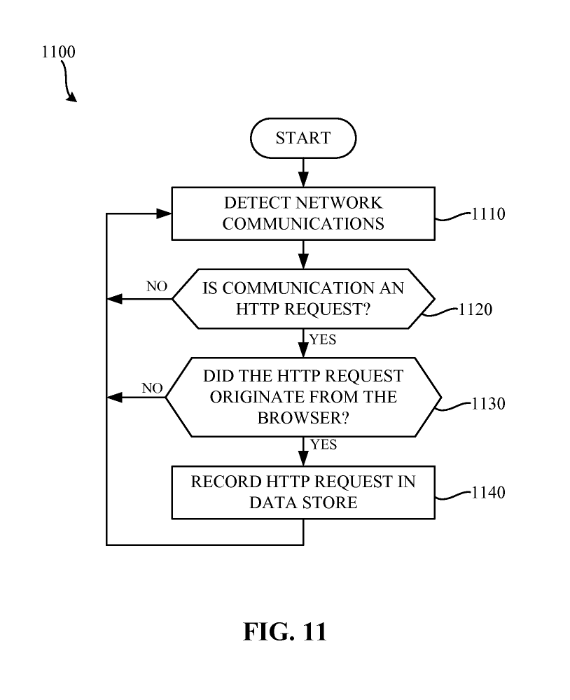

FIG. 10 is a flowchart 1000 representative of example machine-readable instructions that may be executed to implement the example browser monitor 230 of FIGS. 2 and 3. The example process 1000 begins when the computer 1400 of FIG. 14 is powered on (e.g., the browser monitor 230 executes continuously). However, in some examples, the browser monitor 230 may execute in a more limited fashion such as, for example, when the browser 235 is executed, when a user is actively using the computer 1400, when a threshold amount of communications is detected, etc. The HTTP traffic data gatherer 315 monitors network communications of the network interface 225 (block 1005). The process for monitoring network communications is described in further detail in connection with FIG. 11. The browser information gatherer 305 monitors browser information (block 910) and stores the monitored information in the data store 325. In the illustrated example of FIG. 10, monitoring network communications (block 1005) and monitoring browser information (block 1010) are shown as operating in parallel. However, blocks 1005 and 1010 may be operated in any fashion.

As described in further detail in connection with FIG. 12, the browser monitor 230 further correlates browser information with monitored network communications information stored in the data store 325 (block 1020). However, in some examples, correlation may be performed at a separate location by a separate device. For instance, correlation of the monitored network communications and the monitored browser information may be performed at the data collection site 250 after the monitored information has been transferred to the monitoring data collection site 250.

The data correlator 330 associates the correlated network traffic and browser information with a panelist (e.g., a user, a group of users, a household, etc.) (block 1040). In the illustrated example, a panelist identifier that identifies the panelist associated with the user computer 220 is stored in the data store 325 in association with the correlated information. Additionally or alternatively, the user may be prompted to identify themselves during a browsing session (e.g., at a beginning of the browsing session, at an end of the browsing session, periodically or aperiodically throughout the browsing session, etc.). Further, any other technique for identifying a panelist may additionally or alternatively be used such as, for example, keystroke cadence recognition, biometric identification (e.g., a fingerprint reader), etc. The correlated information is then transmitted to the monitoring data collection site 210 (block 1050). In the illustrated example, the correlated information is transmitted via the Internet. However, the correlated information may be transmitted in any other fashion such as, for example, via a private network, via a storage medium (e.g., a flash drive, a compact disc, etc.), etc.

FIG. 11 is a flowchart 1100 representative of example machine-readable instructions that may be executed to implement block 1005 of FIG. 10. The example machine-readable instructions of FIG. 11 begin execution when the browser monitor 230 begins executing as in FIG. 10. The HTTP traffic data gatherer 315 monitors the network interface 225 to detect network communications (block 1110). In the illustrated example, the HTTP traffic data gatherer 315 determines whether the identified communication is an HTTP request (block 1120). However, the HTTP traffic data gatherer 315 may determine if the identified communication uses any other type and/or protocol (e.g., an HTTP response, an HTTPS message, an FTP message, etc.). If the communication is not an HTTP request, control returns to block 1110 where the HTTP traffic data gatherer continues to identify network communications. If the network communication is an HTTP request, the HTTP traffic data gatherer 315 proceeds to determine whether the HTTP request originated from the browser 235 (block 1130). In the illustrated example, if the HTTP request did not originate from the browser, control proceeds to block 1010 where the HTTP traffic data gatherer continues to identify network communications. If the communication originated from the browser, the data storer 320 stores an identification of the HTTP request (e.g., the contents of the HTTP request, particular fields from the HTTP request, a time that the HTTP request was identified, etc.) in the data store 325.

FIG. 12 is a flowchart 1200 representative of example machine-readable instructions that may be executed to implement block 1010 of FIG. 10. The example machine-readable instructions of FIG. 12 begin execution when the browser monitor 230 begins executing as in FIG. 10. In the illustrated example, the example machine-readable instructions 1200 are executed continuously. The example machine-readable instructions 1200 begin when the browser information gatherer 305 monitors browser information from the browser 235 to detect a change in the Page Info of the displayed page (block 1205). In the illustrated example, the browser information is retrieved via a Page Info interface. However, any other method of retrieving browser information may additionally or alternatively be used. The browser information gatherer 305 then identifies a URL of the displayed page (block 1210). The identified URL represents the page that is displayed in the browser 235. In some examples, the page displayed in the browser will instruct the browser 235 to retrieve and/or display additional media elements (e.g., images, iframes, animations, videos, etc.). The URL identified from the browser information represents a parent call.

The browser information gatherer 305 of the illustrated example then identifies media elements to be requested and/or displayed on the web page identified by the parent call (block 1215). In the illustrated example, media elements are identified by inspecting the Page Info interface of the browser which, in some examples, exposes information associated with each media element displayed on a web page (as described in connection with FIG. 6). However, in some examples, information associated with each media element displayed on the web page is not available via the Page Info interface (as described in connection with FIG. 5). In such examples, the browser information gatherer 305 may identify media elements by accessing the document object model (DOM) to identify media elements, extracting and/or parsing a source code (e.g., the HTML) of the displayed webpage from the browser, and/or using a properties interface provided by the browser 235. The DOM is a cross-platform and language-independent convention for representing and interacting with objects in Hypertext Markup Language (HTML). The DOM represents webpage elements in a hierarchical organization based on how the elements are displayed. As the elements displayed on the webpage are updated (e.g., by rotating advertisements), the DOM is updated. By inspecting the DOM, it is possible to identify elements displayed by the browser as part of the webpage. Additionally, identifiers and/or properties of the elements (e.g., images, advertisements, widgets, videos, etc.) displayed by the browser (e.g., a height of an element, a width of an element, a URL associated with an element, etc.) may be identified and or parsed from the DOM.

Furthermore, the browser information gatherer 305 may retrieve a source code of the displayed webpage from the browser to facilitate identification of elements displayed by the webpage. In some examples, the source code is extracted from the browser via a page source interface. However, in some examples, the source code is gathered by the HTTP traffic data gatherer 315 by inspecting the contents of HTTP traffic directed to the browser. By inspecting and/or parsing the source code of the displayed webpage, the browser information data gatherer 305 may identify elements displayed as part of the webpage and/or properties of the elements displayed as part of the webpage.

The browser information gatherer 305 of the illustrated example gathers Page Info from an individual media element displayed on the page (block 1220). In the illustrated example, the Page Info is gathered through the Page Info interface of the browser. However, in some examples, the properties interface of the browser 235 is used to gather the Page Info. In some examples, the Page Info indicates properties of the media element such as, for example, a URL of the media element, a dimension of the media element, a last modified date, a type, a file size, etc. The browser information gatherer 305 of the illustrated example identifies the requested URL of the media element from the retrieved Page Info (block 1225). The data storer 320 records an identification of the media in association with the displayed page (block 1230) in the data store 325. Recording such an association enables correlation of what media elements (e.g., images, advertisements, videos, etc.) were displayed on the page hosted by the content providing site 205, and where those media elements were hosted (e.g., the content delivery network 260).

The browser information gatherer 305 then determines whether additional media elements are present on the displayed webpage (block 1250). If additional media elements are present, the browser information gatherer 305 proceeds to identify the remaining media elements displayed on the webpage (block 1215). If no additional media elements are present, the browser information gatherer monitors the browser 235 for changes in Page Info of the displayed page (block 1205).

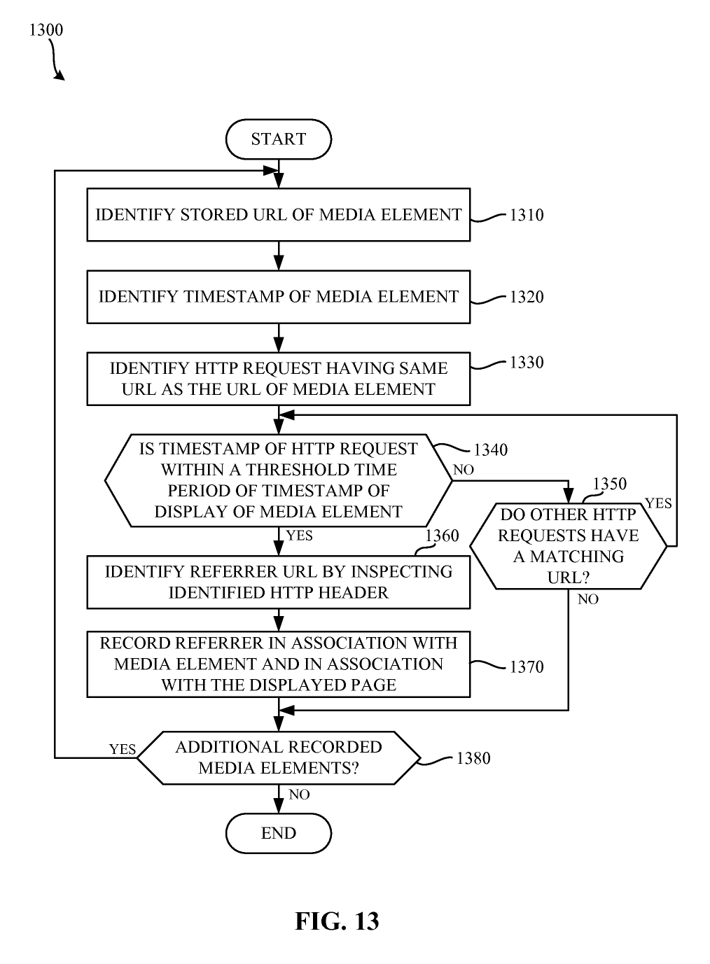

FIG. 13 is a flowchart 1300 representative of example machine-readable instructions that may be executed to implement block 1020 of FIG. 10. The example machine-readable instructions of FIG. 13 begin execution when the browser monitor 230 begins executing as in FIG. 10. In the illustrated example, the example machine-readable instructions 1300 are executed continuously. However, in some examples, the example machine-readable instructions 1300 are executed periodically or aperiodically. For example, the instructions may be executed at the end of a browsing session. The data correlator 330 identifies a stored URL of a media element. (block 1310). The data correlator 330 identifies a timestamp of the media element (block 1320).

Based on the identified URL of the media element, the data correlator 330 inspects the data store 325 to identify an HTTP request having the same URL as the URL of the identified media element. (block 1330). In the illustrated example, it is assumed that an HTTP request can be associated with each media element displayed as part of a webpage. However in some examples, an HTTP request may not be made in association with each element. For example, some elements may be cached and/or stored locally such that the browser does not need to re-request the media elements for their display. When no HTTP request can be identified, the data correlator 330 only associates the media element as having been displayed in association with the website.

The data correlator 330 determines whether the timestamp of the identified HTTP request is within a threshold time period of the timestamp of the display of the media element. (block 1340). In the illustrated example, if the HTTP request was transmitted within five seconds of the media element being displayed, a match is assumed. However any other threshold and/or way of associating the display of media elements with HTTP requests may additionally or alternatively be used. If the timestamp of the identified HTTP request is not within the threshold time period of the timestamp of the display of the media element, the data correlator 330 determines if any other HTTP requests stored in the data store 325 have a matching URL (block 1350). If any other HTTP requests have a matching URL, the data correlator 330 determines if the timestamp of the identified HTTP request is within the threshold time period of the display of the media element. If no other HTTP requests have a matching URL, the data correlator 330 proceeds to determine if additional media elements were displayed (block 1380).

If the timestamp of the identified HTTP request is within the threshold time period of the timestamp of the display of the media element, the data correlator inspects the identified HTTP request to identify a referrer URL of the HTTP request (block 1360). In the illustrated example, the referrer is identified by inspecting the referrer field (e.g., the referrer field 730 of FIG. 7) to identify a site that caused the browser to make the HTTP request. The referrer identifies an intermediate provider which, in many cases, is an advertisement network. Identifying the advertisement network enables association of the advertisement network with the parent call as well as association of the advertisement network with the displayed advertisement. The data storer 320 of the illustrated example stores the referrer in association with the individual media (thereby associating the advertisement with the advertisement network) and in association with the displayed page (thereby associating the advertisement network with the displayed page). (block 1370).

The data correlator 330 then determines whether additional media elements are present in the data store 325 (block 1380). If additional media elements are present, the data correlator 330 proceeds to correlate the media elements with HTTP requests. If no additional media elements are present, the process terminates.

FIG. 14 is a block diagram of an example processor platform 1400 that may execute, for example, the machine-readable instructions of FIGS. 10, 11, 12, and/or 13 to implement the example browser monitor of FIGS. 2 and/or 3. The processor platform 1400 can be, for example, a server, a personal computer, a mobile phone (e.g., a cell phone), a personal digital assistant (PDA), an Internet appliance, a DVD player, a digital video recorder, a Blu-ray player, a gaming console, a personal video recorder, a set top box, or any other type of computing device.

The processor platform 1400 of the instant example includes a processor 1412. For example, the processor 1412 can be implemented by one or more microprocessors or controllers from any desired family or manufacturer.

The processor 1412 includes a local memory 1413 (e.g., a cache) and is in communication with a main memory including a volatile memory 1416 and a non-volatile memory 1414 via a bus 1418. The volatile memory 1416 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a memory controller.

The processor platform 1400 also includes an interface circuit 1420. The interface circuit 1420 may be implemented by any type of interface standard, such as an Ethernet interface, a universal serial bus (USB), and/or a PCI express interface.

One or more input devices 1422 are connected to the interface circuit 1420. The input device(s) 1422 permit a user to enter data and commands into the processor 1412. The input device(s) can be implemented by, for example, a keyboard, a mouse, a touchscreen, a track-pad, a trackball, isopoint, and/or a voice recognition system.

One or more output devices 1424 are also connected to the interface circuit 1420. The output devices 1424 can be implemented, for example, by display devices (e.g., a liquid crystal display, a cathode ray tube display (CRT), a printer, and/or speakers). The interface circuit 1420, thus, typically includes a graphics driver card.

The interface circuit 1420 also includes a communication device (e.g., the network interface 225, the data communicator 335) such as a modem or network interface card to facilitate exchange of data with external computers via a network 1426 (e.g., an Ethernet connection, a digital subscriber line (DSL), a telephone line, coaxial cable, a cellular telephone system, etc.).

The processor platform 1400 also includes one or more mass storage devices 1428 for storing software and data. Examples of such mass storage devices 1428 include floppy disk drives, hard drive disks, compact disk drives and digital versatile disk (DVD) drives. The mass storage device 1428 may implement the data store 325.

The coded instructions 1432 of FIGS. 10, 11, 12, and/or 13 may be stored in the mass storage device 1428, in the volatile memory 1416, in the non-volatile memory 1414, and/or on a removable storage medium such as a CD or DVD.

From the foregoing, it will appreciated that the above disclosed methods, apparatus and articles of manufacture enable association of web providers with advertisement networks as well as association of advertisement networks with advertisements.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to monitor advertisement placements, the method comprising:
identifying, by inspecting a Page Info interface of a browser with a processor, a first universal resource locator (URL) of a webpage displayed by the browser;
identifying a media element displayed on the webpage;
gathering a second URL associated with the media element displayed on the webpage;
inspecting a log of network communications to identify a request for the second URL;
identifying a referrer URL within a header of the request, the referrer URL being different from the first URL; and
storing a record of the referrer URL in association with the first URL.

2. The method as described in claim 1, wherein the media element is identified by inspecting the Page Info interface of the browser.

3. The method as described in claim 1, wherein the media element is identified by inspecting a document object model (DOM) of the browser.

4. (canceled)

5. The method as described in claim 1, further comprising retrieving source code of the webpage from the browser.

6. The method as described in claim 1, wherein the second URL is gathered by inspecting the Page Info interface of the browser.

7. (canceled)

8. The method as described in claim 1, further comprising:
detecting a message transmitted via a network interface; and
recording the message in the log of network communications.

9. The method as described in claim 8, wherein detecting the message further comprises determining whether the message is a HyperText Transfer Protocol (HTTP) request; and recording the message further comprises recording the message in the log of network communications when the message is an HTTP request.

10. The method as described in claim 8, wherein detecting the message further comprises determining whether the message originated from the browser; and recording the message further comprises recording the message in the log of network communications when the message originated from the browser.

11. The method as described in claim 1, wherein inspecting the log to identify the request comprises selecting a request having a timestamp within a threshold time range of a time that the webpage was displayed by the browser.

12. The method as described in claim 1, further comprising storing a record of the referrer URL in association with the second URL.

13. The method as described in claim 1, further comprising storing a panelist identifier in association with the record.

14. (canceled)

15. An apparatus to identify an Internet advertising network, the apparatus comprising:
a browser information gatherer to gather browser information from a Page Info interface of a browser;
a HyperText Transfer Protocol (HTTP) traffic data gatherer to monitor network communications of a network interface associated with the browser;
a data correlator to correlate the browser information with the network communications to identify a referrer universal resource locator (URL) of an element displayed on a webpage, the webpage having a webpage URL, the element having an element URL; and
a data storer to store a record associating the referrer URL with the webpage URL in a data store.

16. (canceled)

17. The apparatus as described in claim 15, wherein the data storer is to store a second record associating the referrer URL and the element URL in the data store.

18. (canceled)

19. The apparatus as described in claim 15, wherein the data storer is to store a panelist identifier in association with the record.

20. The apparatus as described in claim 15, wherein the browser information gatherer is further to identify the element displayed on the webpage via the Page Info interface.

21. A tangible computer-readable storage medium comprising instructions which, when executed, cause a machine to at least:
identify by inspecting a Page Info interface of a browser, a first universal resource locator (URL) of a webpage displayed by the browser;
identify a media element displayed on the webpage;
gather a second URL associated with the media element displayed on the webpage;
inspect a log of network communications to identify a request for the second URL;
identify a referrer URL within a header of the request, the referrer URL being different from the first URL; and
store a record of the referrer URL in association with the first URL.

22. (canceled)

23. (canceled)

24. (canceled)

25. The computer-readable storage medium as described in claim 21, further comprising retrieving source code of the webpage from the browser.

26. (canceled)

27. (canceled)

28. The computer-readable storage medium as described in claim 21, further storing instructions which, when executed, cause the machine to at least:
detect a message transmitted via a network interface; and
record the message in the log of network communications.

29. The computer-readable storage medium as described in claim 28, further storing instructions which, when executed, cause the machine to at least:
determine whether the message is a HyperText Transfer Protocol (HTTP) request; and
record the message in the log of network communications when the message is an HTTP request.

30. The computer-readable storage medium as described in claim 28, further storing instructions which, when executed, cause the machine to at least:
determine whether the message originated from the browser; and
record the message in the log of network communications when the message originated from the browser.

31. (canceled)

32. (canceled)

33. (canceled)

34. (canceled)

35. (canceled)

36. (canceled)

37. (canceled)

38. (canceled)

39. (canceled)
